(19) United States
(12) Patent Application Publication
(10) Pub. No.: US 2009/0056129 A1
(43) Pub. Date: Mar. 5, 2009

(54) Method for Manufacturing Liquid Ejecting Head and Method for Manufacturing Liquid Ejecting Apparatus

(75) Inventor: Nao TAKEUCHI, Matsumoto-shi (JP)

Correspondence Address: HOGAN & HARTSON L.L.P., 1999 AVENUE OF THE STARS, SUITE 1400, LOS ANGELES, CA, 90067, US

(73) Assignee: SEIKO EPSON CORPORATION, Tokyo (JP)

(21) Appl. No.: 12/203,798

(22) Filed: Sep. 3, 2008

(30) Foreign Application Priority Data
Sep. 3, 2007 (JP) 2007-227439

(51) Int. Cl. B23P 17/00

(52) U.S. Cl. 29/890.1

(57) ABSTRACT

A method for manufacturing a liquid ejecting head that has: positioning an actuator unit, which has a plurality of driving elements, and a line member, which applies a driving signal to the driving element, with an anisotropic electro-conductive material being sandwiched between the actuator unit and the line member in such a manner that the actuator unit and the line member substantially overlap each other when viewed in plan; and applying pressure to an overlapping area where the actuator unit and the line member substantially overlap each other when viewed in plan with the use of a compression bonding device so as to adhere the actuator unit and the line member to each other as a result of compression.

### BACKGROUND

1. Technical Field

The present invention generally relates to a method for manufacturing a liquid ejecting head that can be suitably used for ejecting various kinds of liquid (functional liquid) such as ink or the like. The invention further relates to a method for manufacturing a liquid ejecting apparatus that is provided with a liquid ejecting head that is manufactured by such a liquid-ejecting-head manufacturing method. In particular, the invention relates to the manufacturing method of a liquid ejecting head and the manufacturing method of a liquid ejecting apparatus that includes, as a manufacturing process thereof, the bonding of a line member to a cluster of piezoelectric elements with the use of an anisotropic conductive film. The line member mentioned above supplies a driving signal to the piezoelectric element.

2. Related Art

In the technical field to which the present invention pertains, various kinds of liquid ejecting heads are known, one non-limiting example of which is an ink-jet recording head. The liquid ejecting head is used as a component of a liquid ejecting apparatus. A liquid ejecting head that has, for example, a fluid channel unit, an actuator unit, and a case is also known in the related art. The fluid channel unit of a liquid ejecting head of the related art has an ink flow passage, which includes a common ink-retaining chamber, a pressure generation chamber, and a nozzle hole. Ink retained in the common ink-retaining compartment flows into the pressure generation compartment, and then, is discharged through the nozzle hole. The actuator unit is provided at the back of the fluid channel unit. The actuator unit has a plurality of piezoelectric elements, which is hereafter referred to as a cluster of piezoelectric elements. The piezoelectric element changes the ink-retaining capacity of the pressure generation chamber for the ejection of ink. The case has an inner container space for housing the actuator unit. That is, the actuator unit is mounted inside the container space of the case. The fluid channel unit is adhered to the front surface of the case. In the following description of this background of the invention, an ink-jet recording head having the configuration described above is referred to as a recording head.

As a typical configuration thereof, the actuator unit has external electrodes. More specifically, the actuator unit has individual external electrodes each of which is provided for the corresponding one of the plurality of piezoelectric elements and a common external electrode that is common to all of the plurality of piezoelectric elements. A line member is electrically connected to these external electrodes. A driving signal is applied to the piezoelectric element via the line member. A film member such as a tape carrier package (TCP) or a chip on film (COP) is suitably used as the line member mentioned above.

In most cases, soldering has been conventionally used to adhere each line terminal of the line member to the corresponding external electrode of the actuator. These days, since packaging density increases with an increasing demand for finer print, however, it is difficult to achieve a finer pitch, a smaller head, and a larger number of nozzles if soldering is used to adhere the flexible substrate to the piezoelectric elements. In addition, soldering is not environmentally friendly. Legal restrictions are imposed on the use of a fluorocarbon solvent (i.e., chlorofluorocarbon solvent) for washing in the removal of a flux residue nowadays. The use of a soldering method is against increasing awareness about lead-free (i.e., Pb-free) and environmentally friendly production. Moreover, soldering has a disadvantage in terms of production efficiency. Furthermore, it deteriorates as time elapses. The poor production efficiency of soldering and aged deterioration thereof results in increased production cost and decreased product reliability.

In an effort to overcome such a disadvantage, an anisotropic conductive adhesion method has been proposed in the related art as a substitute for a soldering method. In anisotropic conductive adhesion, each line terminal of a line member is adhered to the corresponding external electrode of an actuator with the use of an anisotropic electro-conductive material. An example of an anisotropic conductive adhesion method of the related art is described in JP-A-2000-289200. An anisotropic electro-conductive material has, as a dispersion medium, an epoxy thermo-hardening resin paste or film. Electro-conductive particles are dispersed in the thermosetting adhesive resin mentioned above. The above-mentioned electro-conductive particles are, for example, metal particles such as tin-nickel alloy or nickel alone. Or, alternatively, these electro-conductive particles may be, for example, nickelized (i.e., nickel-plated) or gold-plated particles each of which has a core resin made of styrene, divinylbenzene, or benzoguanamine, though not limited thereto.

In the proposed anisotropic conductive adhesion method of the related art, each line terminal of a line member (e.g., flexible cable) is adhered to the corresponding external electrode of an actuator with the use of an anisotropic electro-conductive material as follows. An anisotropic electro-conductive material is applied or pasted onto an area that has a certain width and includes the regions of external electrodes over an actuator unit. Then, each line terminal of the flexible cable is laid over the corresponding external electrode of the actuator with the anisotropic electro-conductive material being sandwiched therebetween in such a manner that the above-mentioned each line terminal of the flexible cable substantially overlaps the above-mentioned corresponding external electrode of the actuator unit when viewed in plan. Thereafter, a heat-compressing tool, which is a thermo-compression bonding device, is used to apply pressure to an area corresponding to the anisotropic electro-conductive material area while heating this area. More specifically, the heat-compressing tool presses the surface of the flexible cable at the above-explained area toward the actuator unit while heating this surface. As a result of the application of heat and pressure thereto with the use of the heat-compressing tool, the flexible cable is adhered to the actuator unit through thermo-compression bonding.

During the thermo-compression bonding process described above, the setting of a pressure load that is applied by the heat-compressing tool to a target area where electric conduction is required is very important in order to ensure a reliable electric conduction between each line terminal of the flexible cable and the corresponding external electrode of the actuator. That is, if an insufficient pressure load is applied to the target area where electric conduction is required, it is impossible to secure a sufficient contact area at which the electro-conductive particles of the anisotropic electro-conductive material are in contact with the line terminals of the flexible cable at one side and the external electrodes of the actuator unit at the other side. As a result thereof, an electric resistance increases, which is not desirable. Conversely, if a pressure load that is applied to the target area where electric conduction is required is too large, the electro-conductive particles of the anisotropic electro-conductive material may be damaged. If the electro-conductive particles of the anisotropic electro-conductive material are damaged, an electric resistance increases.

Since the heat-compressing tool applies pressure to an area that includes a non-external-electrode region, which is an area other than an external-electrode region and corresponds to a non-conduction region where electric conduction is not required, it is practically impossible or at best difficult to achieve a uniform pressure load for each region. For this reason, at the first-mentioned area where electric conduction is required, a significant dispersion (i.e., variability or variation) occurs in the contact area at which the electro-conductive particles of the anisotropic electro-conductive material are in contact with the line terminals of the flexible cable at one side and the external electrodes of the actuator unit at the other side. This makes it practically impossible or at best difficult to ensure a reliable electric conduction between each line terminal of the flexible cable and the corresponding external electrode of the actuator.

### SUMMARY

An advantage of some aspects of the invention is to provide a method for manufacturing a liquid ejecting head that is capable of avoiding the occurrence of any significant variation (i.e., dispersion or variability) in pressure loads applied to an area where electric conduction is required in a compression bonding process during which an actuator unit and a line member are “press-bonded” to each other, or, in other words, a compression bonding process during which an actuator unit and a line member are bonded to each other as a result of compression, with an anisotropic electro-conductive material being sandwiched therebetween. In addition, the invention further provides, as an advantage of some aspects thereof, a method for manufacturing a liquid ejecting apparatus that is provided with a liquid ejecting head that is manufactured by such a liquid-ejecting-head manufacturing method (or a method for manufacturing a liquid ejecting apparatus that is provided with such a liquid ejecting head).

In order to address the above-identified problem without any limitation thereto, the invention provides, as a first aspect thereof, a method for manufacturing a liquid ejecting head that includes: positioning an actuator unit, which has a plurality of driving elements, and a line member, which applies a driving signal to the driving element, with an anisotropic electro-conductive material being sandwiched between the actuator unit and the line member in such a manner that the actuator unit and the line member substantially overlap each other when viewed in plan; and applying pressure to an overlapping area where the actuator unit and the line member substantially overlap each other when viewed in plan with the use of a compression bonding device so as to adhere the actuator unit and the line member to each other as a result of compression, wherein (1) the plurality of driving elements has individual external electrodes each of which is provided for the corresponding one of the plurality of driving elements and further has a common external electrode that is common to all of the plurality of driving elements, and the common external electrode is provided at an outside corner area, which is located at a region close to, or at least relatively close to, the rear end of the plurality of driving elements on a line connection surface thereof; (2) the actuator unit has a first area where line terminals of the line member are positioned so as to overlap the individual external electrodes and the common external electrode when viewed in plan, which will be followed by compression bonding, and further has a second area which is different from the first area, and the compression bonding is also performed at the second area, and (3) the compression bonding device applies, to the first area, a pressure load that is larger than that applied to the second area at each one application of the pressure load. In the method for manufacturing a liquid ejecting head according to the first aspect of the invention described above, it is preferable that the first area should be an area where electric conduction is required. In addition, in the method for manufacturing a liquid ejecting head according to the first aspect of the invention described above, it is preferable that the compression bonding should be thermo-compression bonding.

In the method for manufacturing a liquid ejecting head according to the first aspect of the invention described above, including its preferred features described in the preceding sentence, the compression bonding device applies, to the first area, which is an area where electric conduction is required, a pressure load that is larger than that applied to the second area, which is an area where electric conduction is not required, at each one application of the pressure load. In other words, during the compression bonding (preferably, thermo-compression bonding), the pressure load of the compression bonding device focuses on, that is, is intensively applied to, the first area where electric conduction is required. For this reason, it is possible to avoid the occurrence of any significant dispersion (i.e., variability or variation) in pressure loads applied to the first area where electric conduction is required in the (thermo-) compression bonding. Thus, the method for manufacturing a liquid ejecting head according to the first aspect of the invention described above, including its preferred features described above, makes it possible to achieve a stable connection resistance value at the first area where electric conduction is required. As a result thereof, it is possible to offer reliable electrical conduction at the first area where electric conduction is required. Moreover, in the method for manufacturing a liquid ejecting head according to the first aspect of the invention described above, including its preferred features described above, when viewed in plan, the common external electrode is provided at an (i.e., at least one) outside corner area, which is located at a region close to, or at least relatively close to, the rear end of the plurality of driving elements (e.g., cluster of piezoelectric elements) on a line connection surface thereof. Because of such a structure, the pressure load of the compression-bonding device is intensively applied to an area corresponding to the common external electrode. Therefore, it is possible to achieve pressure bonding thereat in a reliable manner. It should be noted that, generally speaking, an outside corner area (e.g., each of two outside corner areas), which is located at a region close to, or at least relatively close to, the rear end of the plurality of driving elements on the line connection surface thereof is a region where there is a relatively great risk that the line member comes off. In this respect, the method for manufacturing a liquid ejecting head according to the first aspect of the invention described above, including its preferred features described above, makes it possible to reinforce the adhesion of the line member to the actuator unit with reliable pressure bonding at such a vulnerable area. Thus, the method for manufacturing a liquid ejecting head according to the first aspect of the invention described above, including its preferred features described above, makes it possible to avoid the line member from coming away from the actuator unit.

In the method for manufacturing a liquid ejecting head according to the first aspect of the invention described above, it is preferable that (1) the pressing surface of the compression bonding device should have a level difference in such a manner that a first pressing area portion thereof, which corresponds to the first area, is protruded in a pressing direction toward a pressure application target as viewed from a second pressing area portion thereof, which corresponds to the second area, and (2) during the compression bonding of the actuator unit and the line member to each other, which is a process during which the compression bonding device applies pressure to the surface thereof, the first pressing area portion thereof should become in contact with the first area.

Such a structure can be obtained by changing the configuration of the pressing surface of the compression-bonding device. That is, it is possible to perform compression bonding without any necessity to modify the structure, configuration, or the like, of other device.

In order to address the above-identified problem without any limitation thereto, the invention provides, as a second aspect thereof, a method for manufacturing a liquid ejecting apparatus that is provided with a liquid ejecting head that is manufactured by the liquid-ejecting-head manufacturing method according to the first aspect of the invention described above.

### BRIEF DESCRIPTION OF THE DRAWINGS

The invention will be described with reference to the accompanying drawings, wherein like numbers reference like elements.

FIG. 1 is a sectional view that schematically illustrates, in an enlarged view, an example of the essential components of a recording head according to an exemplary embodiment of the invention.

FIG. 2 is a sectional view that schematically illustrates, in an enlarged view, an example of the essential components of a piezoelectric element unit according to an exemplary embodiment of the invention.

FIG. 3 is a plan view that schematically illustrates an example of the two-dimensional configuration of a piezoelectric element unit according to an exemplary embodiment of the invention.

FIG. 4 is a plan view that schematically illustrates an example of the two-dimensional configuration of a plurality of piezoelectric elements according to an exemplary embodiment of the invention; more specifically, FIG. 4 illustrates an exemplary plan view of a cluster of piezoelectric elements taken at a certain production process prior to the bonding of a flexible cable thereto.

FIG. 5 is a plan view that schematically illustrates an exemplary configuration of the pressing surface of a heat-compressing tool according to an exemplary embodiment of the invention.

FIG. 6 is a sectional view that schematically illustrates an example of the thermo-compression bonding of a flexible cable to an actuator unit, which is performed, as an exemplary embodiment of the invention, with the use of a heat-compressing tool.

### DESCRIPTION OF EXEMPLARY EMBODIMENTS

With reference to the accompanying drawings, the best mode for carrying out the present invention is described below. Although various specific features are explained in the following exemplary embodiments of the invention in order to disclose preferred modes thereof, the invention should be in no case interpreted to be limited to the specific embodiments described below unless any intention of restriction is explicitly shown. The invention may be modified, altered, changed, adapted, and/or improved within a range not departing from the gist and/or spirit of the invention apprehended by a person skilled in the art from explicit and implicit description given herein as well as from recitation of appended claims. A method for manufacturing a liquid ejecting head that is subjected to such modification, alteration, change, adaptation, and/or improvement is also within the technical scope of the invention. The same holds true for a method for manufacturing a liquid ejecting apparatus that is provided with a liquid ejecting head that is manufactured by such a liquid-ejecting-head manufacturing method subjected thereto. In the following description of this specification, an ink-jet recording head is taken as an example of various kinds of liquid ejecting heads that can be built in a liquid ejecting apparatus according to an aspect of the invention. Hereafter, an ink-jet recording head may be simply referred to as a recording head.

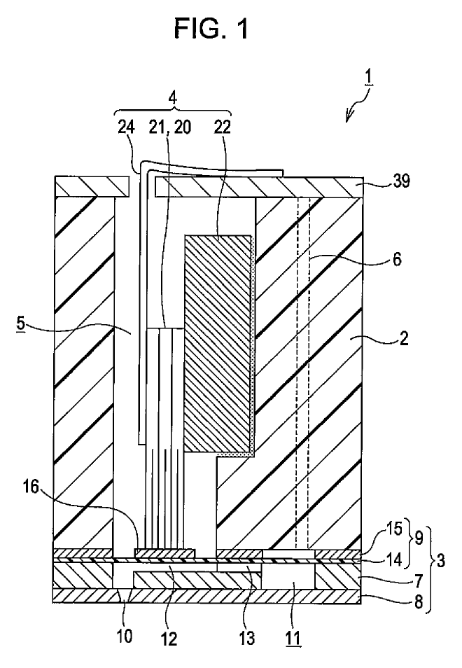

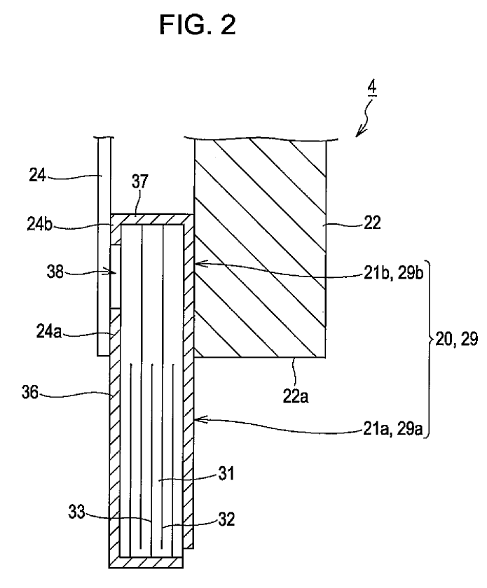

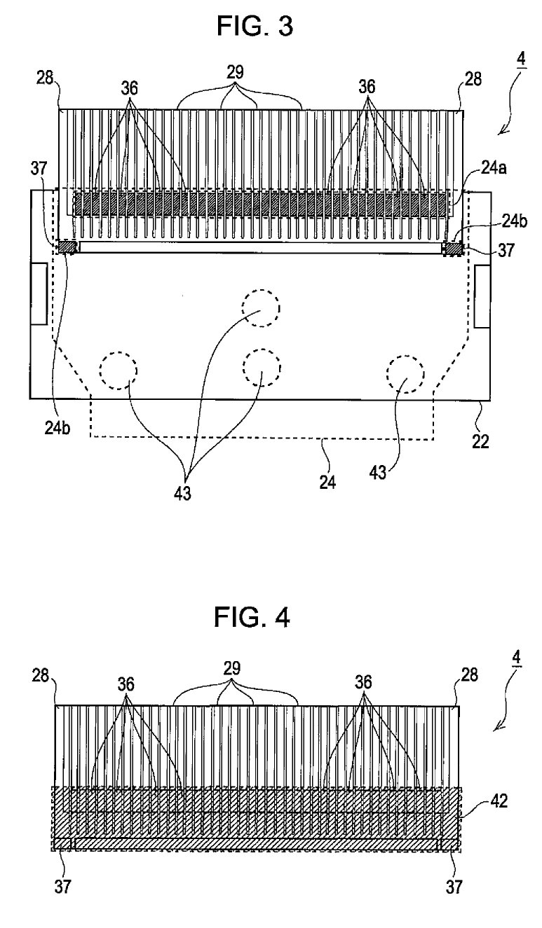

FIG. 1 is a sectional view that schematically illustrates, in an enlarged view, an example of the essential components of a recording head 1 according to an exemplary embodiment of the invention. FIG. 2 is a sectional view that schematically illustrates, in an enlarged view, an example of the essential components of a piezoelectric element unit according to an exemplary embodiment of the invention. FIG. 3 is a plan view that schematically illustrates an example of the two-dimensional configuration of a piezoelectric element unit according to an exemplary embodiment of the invention. FIG. 4 is a plan view that schematically illustrates an example of the two-dimensional configuration of a plurality of piezoelectric elements (hereafter may be referred to as “a cluster of piezoelectric elements”) according to an exemplary embodiment of the invention. It should be noted that FIG. 4 illustrates an exemplary plan view of a cluster of piezoelectric elements taken at a certain production process prior to the bonding of a flexible cable thereto.

The recording head 1 is mainly made up of a case 2, a fluid channel unit 3, and a piezoelectric element unit 4, though not limited thereto. The case 2 is a block member that is made of synthetic resin. The case has an open top and an open bottom. A container space 5 is formed inside the case 2. The opening of the container space 5 is elongated in the nozzle-line direction. In other words, the container space 5 has an opening shape that is elongated in the direction along which a plurality of elements is arrayed. A more detailed explanation thereof will be given later. The fluid channel unit (e.g., flow channel unit, flow path unit, or the like) 3 is adhered to the front surface of the case 2 by bonding or any other alternative adhesion method. In the illustrated exemplary configuration of the recording head 1, the front surface of the case 2 corresponds to the bottom surface thereof. The piezoelectric element unit 4 is housed in the container space 5. The piezoelectric element unit 4 is fixed inside the container space 5. An inner-case flow passage (e.g., inner-case fluid channel, inner-case flow channel, inner-case flow path, or the like) 6 is formed at a short distance away from the side of the container space 5 inside the case 2. Ink supplied from an ink-supply source such as an ink cartridge, an ink tank, a valve unit (i.e., self-sealing valve), or the like flows through the inner-case flow passage 6 to enter the reservoir side of the fluid channel unit 3. The inner-case flow passage 6 is formed through the case 2 along the height direction thereof.

The fluid channel unit 3 is made up of a fluid channel formation plate 7, a nozzle plate 8, and an elastic plate 9. The fluid channel formation plate 7, the nozzle plate 8, and the elastic plate 9 are formed as a lamination of plates, that is, a multi-layer fluid channel unit 3. The nozzle plate 8 is a thin plate-like member that has a number of nozzle openings (e.g., nozzle holes, nozzle orifices, or the like) 10. For example, three hundred and sixty (360) nozzle holes 10 are arrayed adjacent to one another so as to form nozzle line(s) on the nozzle plate 8. These nozzle holes 10 are arrayed with a predetermined nozzle pitch, which corresponds to dot formation density. The nozzle plate 8 is made of, for example, stainless steel. The fluid channel formation plate 7 is formed over the nozzle plate 8. The fluid channel formation plate 7 has a reservoir 11, a pressure generation chamber (i.e., pressure generation compartment) 12, and an ink-supply passage (i.e., ink communication path) 13, though not limited thereto. As has already been described above, ink supplied from an ink-supply source flows through the inner-case flow passage 6 and then flows into the reservoir 11. The pressure generation chamber 12 generates pressure that is required for ejecting ink from the nozzle hole 10. Ink that has flown into the reservoir 11 further flows through the ink-supply passage 13 to enter the pressure generation chamber 12. That is, the reservoir 11 and the pressure generation chamber 12 are in communication with each other via the ink-supply passage 13. In the configuration of the recording head 1 according to the present embodiment of the invention, each of the reservoir 11, the pressure generation chamber 12, and the ink-supply passage 13 is formed as a result of the etching of a silicon wafer. Notwithstanding the above, however, other material may be used for the formation of the fluid channel formation plate 7 as a substitute for silicon. For example, the fluid channel formation plate 7 may be made of a metal plate or the like.

In the configuration of the recording head 1 according to the present embodiment of the invention, the elastic plate 9 has a bi-layer structure. More specifically, the elastic plate 9 is made up of an elastic membrane 14 and a stainless plate 15, the former of which is laminated on the latter (in the illustrated exemplary configuration of the elastic plate 9, the latter is formed “over” the former (refer to FIG. 1)). The elastic membrane 14 is made of a polymer membrane such as polyphenylene sulfide (PPS) or the like. The stainless plate 15 (elastic plate 9) has an “island” portion 16. The island portion 16 is formed by an etching method. More specifically, a ring-shaped area portion around the island portion 16 of the stainless plate 15 has been etched away. The remaining island portion 16 is located at a position corresponding to the pressure generation chamber 12. At the ring-shaped area portion thereof, the elastic membrane 14 only remains after the etching process. On the other hand, at the island portion 16, both of the elastic membrane 14 and the stainless plate 15 remain without being etched away. The island portion 16 is a block component that has an upper surface, which is opposite to a lower surface that faces toward the pressure generation chamber 12. The front-end face of a piezoelectric element is adhered to the above-mentioned top surface of the island portion 16. Note that the recording head 1 has a plurality of island portions 16 and a plurality of pressure generation chambers 12. The number of the island portions 16 equals to the number of the pressure generation chambers 12. The island portions 16 are formed with a predetermined island formation pitch, which corresponds to dot formation density.

The nozzle plate 8 is placed on one surface of the fluid channel formation plate 7 whereas the elastic plate 9 is placed on the other surface of the fluid channel formation plate 7. That is, the nozzle plate 8 and the elastic plate 9 are placed so as to sandwich the fluid channel formation plate 7. Then, each of the nozzle plate 8 and the elastic plate 9 is adhered to the fluid channel formation plate 7 by bonding or any other alternative adhesion method so as to make up the fluid channel unit 3. In the configuration of the fluid channel unit 3, the elastic plate 9 functions as a part of a sealing member that seals the case-side (2) surface of the reservoir 11 and the pressure generation chamber 12.

The piezoelectric element unit 4 is mainly made up of a cluster of piezoelectric elements 21, a fixation plate 22, and a flexible cable 24. The cluster of piezoelectric elements 21 is made up of a plurality of piezoelectric elements 20 that are arrayed adjacent to one another. The fixation plate 22, which holds the cluster of piezoelectric elements 21, is made of stainless steel. The flexible cable 24 is used for supplying a driving signal, which drives the cluster of piezoelectric elements 21. The flexible cable 24 described in the present embodiment of the invention is a non-limiting example of a “line member” according to an aspect of the invention. The cluster of piezoelectric elements 21 and the fixation plate 22 described in the present embodiment of the invention make up a non-limiting example of an “actuator unit” according to an aspect of the invention. As shown in FIGS. 2 and 3, the cluster of piezoelectric elements 21 has a free end portion 21a and a fixed end portion 21b. The free end portion 21a of the cluster of piezoelectric elements 21 is a regional portion that is closer to the front end of the element than the fixed end portion 21b thereof. The free end portion 21a of the cluster of piezoelectric elements 21 protrudes as viewed from the front surface (i.e., front-end face) 22a of the fixation plate 22. On the other hand, as shown therein, the fixed end portion 21b of the cluster of piezoelectric elements 21 is fixed to the fixation plate 22. That is, the cluster of piezoelectric elements 21 is fixed to the fixation plate 22 in such a manner that the free end portion 21a thereof, which includes the tip of the element, protrudes as viewed from the front surface 22a of the fixation plate 22. Therefore, the cluster of piezoelectric elements 21 is fixed thereto in the form of a so-called cantilever arm. Among a plurality of elements that make up the cluster of piezoelectric elements 21, two elements each of which is formed at the corresponding end of a line of the piezoelectric elements (20), which are arrayed adjacent to one another, are formed as dummy elements 28. For example, in the illustrated exemplary configuration of the piezoelectric element unit 4 (refer to FIG. 3), each of the leftmost element and the rightmost element is formed as the dummy element 28. Other elements that are arrayed between these two dummy elements 28 are formed as driving elements 29. That is, the cluster of piezoelectric elements 21 includes two dummy elements 28 each of which is formed at the corresponding end of the line and the plurality of driving elements 29 that is formed therebetween.

The driving elements 29 are piezoelectric elements that contribute to the discharging of ink drops (i.e., ejection of ink). The driving elements 29 are driven independently of one another. Each of the driving elements 29 is formed as a needle-like piezoelectric element that has a very small width. For example, the width of each driving element 29 is in the range of 50 μm to 100 μm. On the other hand, the dummy elements 28 are piezoelectric elements that do not contribute to the discharging of ink drops. The dummy elements 28 are formed principally for the purpose of determining the mounting position of the piezoelectric element unit 4 inside the case 2 as viewed in the direction along which the plurality of elements is arrayed. In the configuration of the piezoelectric element unit 4 according to the present embodiment of the invention, each of the driving elements 29, which are included in the cluster of piezoelectric elements 21, expands and contracts in the longitudinal direction (i.e., long-side direction) of the element when it is driven. That is, each of the driving elements 29 is formed as a so-called “length-extension mode vibration” piezoelectric element, which expands and contracts so as to cause longitudinal vibration.

As illustrated in FIG. 2, the driving element 29 has a common internal electrode 32 and an individual internal electrode 33, which are laminated in an alternate manner. A piezoelectric substance (e.g., piezoelectric crystal, though not limited thereto) 31 is sandwiched at each layer between the common internal electrode 32 and the individual internal electrode 33. The common internal electrode 32 is an electrode that is used for setting the same single electric potential level (i.e., voltage level) that is common to all of the plurality of driving elements 29. On the other hand, the individual internal electrode 33 is an electrode that is used for setting an individual electric potential level. The individual voltage levels differ from one driving element 29 to another. The driving element 29 has a free end portion 29a and a fixed end portion 29b. The free end portion 29a of the driving element 29 is a regional portion that is closer to the front end of the element than the fixed end portion 29b thereof as viewed in the longitudinal direction of the element. The free end portion 29a of the driving element 29 occupies approximately two thirds (⅔), one half (½), or so, of the entire length of the element. The remaining portion is formed as the fixed end portion 29b, which is the rear end portion thereof.

As explained above, the common internal electrode 32 and the individual internal electrode 33 are laminated in an alternate manner with the piezoelectric substance 31 being sandwiched at each layer therebetween. The overlapping area of the common internal electrode 32 and the individual internal electrode 33, which functions as an active region (i.e., active area), is formed in the free end portion 29a of the driving element 29. When an electric potential difference (i.e., voltage difference) is applied to the common internal electrode 32 and the individual internal electrode 33, or when it is discharged, the piezoelectric substance 31 deforms at the active area so as to expand or contract in the longitudinal direction of the element. The base end of the common internal electrode 32 is electrically connected to a common external electrode 37 at the rear-end face of the driving element 29. On the other hand, the base end of the individual internal electrode 33 is electrically connected to an individual external electrode 36 at the front-end face of the driving element 29. The individual external electrode 36 is an external electrode that provides electric connection between the individual wiring terminal (i.e., individual line terminal) 24a of the flexible cable 24 and the individual internal electrode 33. The individual wiring terminals 24a are formed at positions (relatively) close to the front end of the flexible cable 24. The individual wiring terminal 24a described in the present embodiment of the invention is a non-limiting example of a “line terminal” according to an aspect of the invention. On the other hand, the common external electrode 37 is an external electrode that provides electric connection between the common wiring terminal (i.e., common line terminal) 24b of the flexible cable 24 and the common internal electrode 32. The common wiring terminal 24b of the flexible cable 24 is formed at positions relatively close to the rear end of the flexible cable 24. The common wiring terminal 24b described in the present embodiment of the invention is also a non-limiting example of a “line terminal” according to an aspect of the invention. The fundamental structure of the dummy element 28, which is formed at each end of a line of piezoelectric elements, which includes the driving elements 29 that are formed between one dummy element 28 and the other dummy element 28, is the same as the structure of the driving element 29 explained above except for the following point of difference. That is, as a non-limiting difference therefrom, the individual wiring terminal 24a of the flexible cable 24 is not electrically connected to the dummy element 28. For this reason, a driving pulse is not applied to the dummy element 28. Thus, the dummy element 28 does not expand and contact as its name indicates.

The flexible cable 24 is formed as follows. A conductive pattern is formed on the surface of an insulation film. The conductor pattern is made of a copper foil. The insulation film is made of polyimide, polyester, or the like. Any area portion thereof other than the line-terminal portions, that is, any regional portion other than terminal-region portions corresponding to the individual wiring terminal 24a and the common wiring terminal 24b, is covered by a resist film. The flexible cable 24 has the structure explained above. The fixed end portion 21b of the cluster of piezoelectric elements 21 has a fixation-plate bonding surface. The fixed end portion 21b of the cluster of piezoelectric elements 21 is adhered to the fixation plate 22 at the fixation-plate adhesion surface thereof. The opposite side of the fixation-plate adhesion surface is formed as a line connection surface 38. Prior to a thermo-compression bonding process, the front-end region of the flexible cable 24 is placed on the line connection surface 38 of the cluster of piezoelectric elements 21. During the thermo-compression bonding process, which is a wiring process, the individual line terminal (i.e., individual wiring terminal) 24a of the flexible cable 24 is electrically connected to the individual external electrode 36. In addition, during the thermo-compression bonding process, the common line terminal (i.e., common wiring terminal) 24b of the flexible cable 24 is electrically connected to the common external electrode 37. The above-mentioned thermo-compression bonding is performed with the use of a heat-compressing tool 44, which is a thermo-compression bonding device. A more detailed explanation of the thermo-compression bonding will be given later. The rear-end region of the flexible cable 24 is electrically connected to a relay substrate 39, which is shown in FIG. 1. A driving pulse that is sent from a printer flows through the relay board 39, which offers an electric relay function, and then is fed to the flexible cable 24.

As has already been explained earlier, the piezoelectric element unit 4 is mounted inside the case 2 as a component of the recording head 1. When the piezoelectric element unit 4 is mounted, the front-end face of the piezoelectric element 20 is placed in contact with the island portion 16 of the elastic plate 9 and then bonded thereto with the use of an adhesive. Accordingly, as shown in FIG. 1, the front-end face of the piezoelectric element 20 (i.e., driving element 29) is connected to (i.e., attached to) the island portion 16 of the elastic plate 9 in such a mounted state.

When a driving pulse is applied to the driving element 29 via the flexible cable 24, the driving element 29 expands/contracts in the longitudinal direction of the element. As a result of the expansion/contraction of the driving element 29, the island portion 16 of the elastic plate 9 moves closer to/away from the pressure generation chamber 12. Since the island portion 16 of the elastic plate 9 moves closer to/away from the pressure generation chamber 12, the pressure generation chamber 12 expands/contracts. Accordingly, the capacity of the pressure generation chamber 12 changes. For example, in order to discharge an ink drop from a certain nozzle hole 10, which is hereafter referred to as “ink-ejection target nozzle”, a driving signal is selectively applied to the piezoelectric element 20 (i.e., driving element 29) that corresponds to the ink-ejection target nozzle 10. Through such selective application of a driving signal, the corresponding pressure generation chamber 12 expands and then contracts. As the pressure generation chamber 12 expands as a result of the selective application of a driving signal, ink retained in the reservoir 11 flows into the pressure generation chamber 12. Then, as the pressure generation chamber 12 contracts, the inner pressure of the ink that is now retained in the pressure generation chamber 12 increases. Accordingly, the ink is pressed out of the pressure generation chamber 12 through the ink-ejection target nozzle 10. In this way, an ink drop is discharged from the ink-ejection target nozzle 10.

Next, a method for manufacturing a liquid ejecting head according to an aspect of the invention is described below. In the following description, more specifically, the compression bonding of an actuator unit according to an aspect of the invention and the flexible cable 24 is explained. Before the compression bonding of an actuator unit according to an aspect of the invention and the flexible cable 24 is explained, the configuration of the actuator unit is described below.

As has already been explained earlier, in the configuration of the recording head 1 according to the present embodiment of the invention, the piezoelectric element unit 4 is mainly made up of the cluster of piezoelectric elements 21 that is fixed to the fixation plate 22, the fixation plate 22 that is made of a metal material such as stainless steel, and the flexible cable 24. The cluster of piezoelectric elements 21 and the fixation plate 22 described in the present embodiment of the invention make up a non-limiting example of an actuator unit according to an aspect of the invention. The front-end region of the flexible cable 24 is electrically connected to the line connection surface 38 of the cluster of piezoelectric elements 21. The individual wiring terminals 24a are arrayed in a line at positions close to the front end of the flexible cable 24. Each of the individual wiring terminals 24a of the flexible cable 24 is formed at a position where, in a plan view, the individual external electrode 36 of the corresponding one of the driving elements 29 included in the cluster of piezoelectric elements 21 is formed. On the other hand, the common wiring terminal 24b of the flexible cable 24 is formed at positions outside the above-mentioned line of the individual wiring terminals 24a. The common wiring terminal 24b is provided at positions closer to the rear end of the flexible cable 24 in comparison with the individual wiring terminals 24a. In other words, the distance between the common wiring terminal 24b and the rear end of the flexible cable 24 is shorter than that between the individual wiring terminals 24a and the rear end of the flexible cable 24. The common wiring terminal 24b of the flexible cable 24 is electrically connected to the common external electrode 37 of the cluster of piezoelectric elements 21.

As illustrated in FIG. 2, the above-mentioned external electrodes 36 and 37 are formed on the surfaces of the cluster of piezoelectric elements 21 except for the side surfaces thereof. These external electrodes 36 and 37, each of which is made of an electro-conductive material, are formed on the non-side surfaces of the cluster of piezoelectric elements 21 by means of a vapor deposition method or a sputtering method. Each of the individual external electrodes 36 is formed on the front-end face of the corresponding one of the plurality of piezoelectric elements 20 (i.e., driving elements 29) and the line connection surface 38 thereof as a single bent electrode. Herein, the term “bent” is used to mean that the front-end-face portion of the individual external electrode 36 and the line-connection-surface (38) portion thereof are not separated from each other without any other intention to limit the technical scope of the invention. The same applies hereafter. At the line-connection-surface (38) portion thereof, the individual external electrode 36 extends from the front end of the driving element 29 toward the rear-end region of the driving element 29. The end region of each of the individual external electrodes 36 that is located in the neighborhood of the rear-end region of the corresponding one of the plurality of driving elements 29 on the line connection surface 38 thereof is an area portion that is electrically connected to the corresponding one of the plurality of the individual wiring terminals 24a of the flexible cable 24. It should be noted that the above-mentioned individual-line-terminal connection regions of the plurality of the individual external electrodes 36 are shown as hatched areas in FIG. 3.

On the other hand, the common external electrode 37 is formed on the fixation-plate bonding surface and the rear-end face of the cluster of piezoelectric elements 21. In addition, a small part of the common external electrode 37 is formed on the line connection surface 38 thereof. The common external electrode 37 is also formed as a single bent electrode. The above-mentioned part of the common external electrode 37 that is formed on the line connection surface 38 thereof is located at a region isolated from, that is, distanced from, the above-mentioned end region (i.e., individual-line-terminal connection region) of the individual external electrode 36. More specifically, the above-mentioned part of the common external electrode 37 that is formed on the line connection surface 38 thereof is located near the rear end of the cluster of piezoelectric elements 21. The common external electrode 37 is bent at one rear-end corner thereof in such a manner that it extends from a small part of the line connection surface 38 to the rear-end face of the cluster of piezoelectric elements 21. More specifically, when viewed in plan, a part of the common external electrode 37 is formed at each of two outside corner areas, which is located at a region close to, or at least relatively close to, the rear end of the cluster of piezoelectric elements 21 on the line connection surface 38 thereof. These two outside corner areas are located at the fixed-end-portion (21b) side of the cluster of piezoelectric elements 21. At each of these two outside corner areas, the part of the common external electrode 37 is formed in a substantially quadrangular shape.

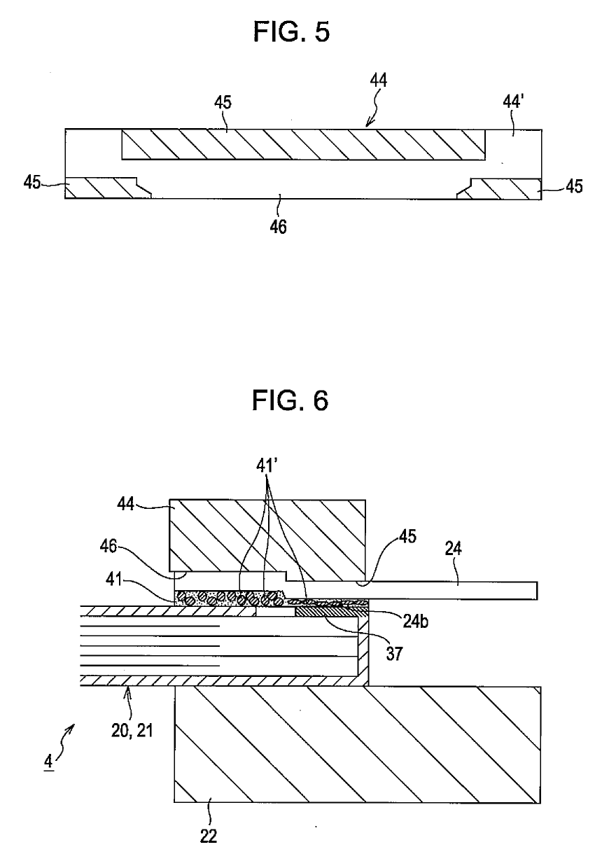

The thermo-compression bonding of the flexible cable 24 to an actuator unit according to an aspect of the invention is performed as follows. An anisotropic conductive adhesive film 41, which is hereafter abbreviated as “ACF”, is pasted on a hatched area (refer to FIG. 4) that includes the individual external electrodes 36 and the common external electrode 37 on the line connection surface 38 of the cluster of piezoelectric elements 21. The above-mentioned hatched area on which the ACF 41 is pasted is hereafter referred to as an “ACF pasting area” 42. The ACF 41 described in the present embodiment of the invention is a non-limiting example of an “anisotropic electro-conductive material” according to an aspect of the invention. An example of the ACF 41 that is pasted on the ACF pasting area 42 is shown in FIG. 6. Each of the individual line terminals 24a of the flexible cable 24 is laid over the corresponding one of the individual external electrodes 36 with the ACF 41 being sandwiched therebetween in such a manner that the individual wiring terminals 24a of the flexible cable 24 substantially overlap the individual external electrodes 36 when viewed in plan. In addition, the common line terminal 24b of the flexible cable 24 is laid over the common external electrode 37 with the ACF 41 being sandwiched therebetween in such a manner that the common wiring terminal 24b of the flexible cable 24 substantially overlaps the common external electrode 37 when viewed in plan. Thereafter, the aforementioned heat-compressing tool 44 is used to apply pressure to an area corresponding to the ACF pasting area 42 while heating this area. The heat-compressing tool 44 described in the present embodiment of the invention is a non-limiting example of a “compression bonding device” according to an aspect of the invention. A non-limiting example of the configuration of the heat-compressing tool 44 is shown in FIGS. 5 and 6. More specifically, the heat-compressing tool 44 presses the surface of the flexible cable 24 at the above-explained area toward an actuator unit according to an aspect of the invention while heating this surface. As a result of the application of heat and pressure thereto with the use of the heat-compressing tool 41, the flexible cable 24 is adhered to an actuator unit according to an aspect of the invention through thermo-compression bonding. As illustrated in FIG. 3, an ultraviolet ray curing adhesive (i.e., ultraviolet hardening-type adhesive) 43 is applied at some places on the piezoelectric-element mount surface of the fixation plate 22. The piezoelectric-element mount surface of the fixation plate 22 is the surface on which the cluster of piezoelectric elements 21 is provided. The above-mentioned some places at which the UV cure adhesive 43 is applied are closer to the rear end of the fixation plate 22 in comparison with the cluster of piezoelectric elements 21. Therefore, the flexible cable 24 is adhered to an actuator unit according to an aspect of the invention through thermo-compression bonding not only at the above-explained area corresponding to the ACF pasting area 42 but also at the above-mentioned some places where the UV cure adhesive 43 is applied. It should be noted that an anisotropic electro-conductive material according to an aspect of the invention is not limited to the ACF 41 explained above. As a non-limiting modification example thereof, an ACP, which is the acronym of anisotropic conductive adhesive paste, may be used in place of the ACF 41. As its name indicates, the ACP is in paste form.

During the thermo-compression bonding of the flexible cable 24 to an actuator unit according to an aspect of the invention, as has already been explained above, each of the individual line terminals 24a of the flexible cable 24 is laid over the corresponding one of the individual external electrodes 36 with the ACF 41 being sandwiched therebetween in such a manner that the individual wiring terminals 24a of the flexible cable 24 substantially overlap the individual external electrodes 36 when viewed in plan. In addition, the common line terminal 24b of the flexible cable 24 is laid over the common external electrode 37 with the ACF 41 being sandwiched therebetween in such a manner that the common wiring terminal 24b of the flexible cable 24 substantially overlaps the common external electrode 37 when viewed in plan. During the thermo-compression bonding explained above, the pressure load of the aforementioned heat-compressing tool 44 focuses on, that is, is intensively applied to, each overlapping area explained above, which is an area where electric conduction is required. A more detailed explanation of this feature is given below.

FIG. 5 is a plan view that schematically illustrates an exemplary configuration of the pressing surface 44′ of the heat-compressing tool 44 according to an exemplary embodiment of the invention. As shown in FIG. 5, the pressing surface 44′ of the heat-compressing tool 44 has a rectangular shape when viewed in plan. The pressing surface 44′ of the heat-compressing tool 44 is elongated in the direction along which the plurality of elements is arrayed. The rectangular shape of the pressing surface 44′ of the heat-compressing tool 44 corresponds to the rectangular shape of the ACF pasting area 42. The longitudinal dimension (i.e., vertical size) of the pressing surface 44′ of the heat-compressing tool 44 is at least slightly larger than that of the ACF pasting area 42. The latitudinal dimension (i.e., horizontal size) of the pressing surface 44′ of the heat-compressing tool 44 is also at least slightly larger than that of the ACF pasting area 42. Some area portion of the pressing surface 44′ of the heat-compressing tool 44 that applies heat and pressure to a target area where electric conduction is required is formed as a first pressing area portion 45. Other area portion of the pressing surface 44′ of the heat-compressing tool 44 that applies heat and pressure to a target area where electric conduction is not required is formed as a second pressing area portion 46. The first pressing area portion 45 of the heat-compressing tool 44 corresponds to the overlapping area where each of the individual line terminals 24a of the flexible cable 24 substantially overlaps the corresponding one of the individual external electrodes 36 when viewed in plan and where the common line terminal 24b of the flexible cable 24 substantially overlaps the common external electrode 37 when viewed in plan. The pressing surface 44′ of the heat-compressing tool 44 has a level difference. The first pressing area portion 45 of the heat-compressing tool 44 is protruded toward a pressure application target as viewed from the second pressing area portion 46 thereof. In other words, the first pressing area portion 45 of the heat-compressing tool 44 is protruded in the pressurizing/compressing direction. The pressurizing/compressing direction described in the present embodiment of the invention is a non-limiting example of a “pressing direction” according to an aspect of the invention. In other words, the second pressing area portion 46 of the heat-compressing tool 44 constitutes a lower area that is “recessed” toward the rear-end surface of the heat-compressing tool 44, which is opposite the pressing surface 44′ thereof, whereas the first pressing area portion 45 of the heat-compressing tool 44 constitutes a higher area.

FIG. 6 is a sectional view that schematically illustrates an example of the thermo-compression bonding of the flexible cable 24 to an actuator unit, which is performed, as an exemplary embodiment of the invention, with the use of the heat-compressing tool 44 that has the structure explained above. It should be particularly noted that FIG. 6 shows a sectional view taken along the longitudinal direction (i.e., long-side direction) of the element at a position where the common external electrode 37 is formed.

As shown in the drawing, during the thermo-compression bonding of the flexible cable 24 to an actuator unit according to the present embodiment of the invention, the heat-compressing tool 44 presses the surface of the flexible cable 24 at the aforementioned area portion corresponding to the ACF pasting area 42 toward the actuator unit while heating this surface. When the heat-compressing tool 44 applies heat and pressure to the surface of the flexible cable 24, the first pressing area portion 45 thereof becomes in contact with the overlapping area where each of the individual line terminals 24a of the flexible cable 24 substantially overlaps the corresponding one of the individual external electrodes 36 when viewed in plan and where the common line terminal 24b of the flexible cable 24 substantially overlaps the common external electrode 37 when viewed in plan. That is, when the heat-compressing tool 44 applies heat and pressure to the surface of the flexible cable 24, the first pressing area portion 45 thereof becomes in contact with a target area where electric conduction is required. Since the first pressing area portion 45 of the heat-compressing tool 44 is protruded in the pressurizing/compressing direction toward a pressure application target as viewed from the second pressing area portion 46 thereof, the pressure load of the aforementioned heat-compressing tool 44 focuses on, that is, is intensively applied to, each overlapping area explained above, which is an area where electric conduction is required (i.e., the overlapping area where each of the individual line terminals 24a of the flexible cable 24 substantially overlaps the corresponding one of the individual external electrodes 36 when viewed in plan and where the common line terminal 24b of the flexible cable 24 substantially overlaps the common external electrode 37 when viewed in plan). For this reason, the collapsing amount of the ACF 41 at this area where electric conduction is required is larger than the collapsing amount of the ACF 41 at an area where electric conduction is not required. Thus, at this area where electric conduction is required, it is possible to secure a large contact area at which the electro-conductive particles 41′ of the ACF 41 are in contact with the individual line terminals 24a of the flexible cable 24 and the common line terminal 24b thereof at one side and the individual external electrodes 36 and the common external electrode 37 at the other side.

On the other hand, when the heat-compressing tool 44 applies heat and pressure to the surface of the flexible cable 24, the second pressing area portion 46 of the heat-compressing tool 44 applies, to the other area where electric conduction is not required, a pressing load (i.e., pressure load) that is smaller than that applied by the first pressing area portion 45 thereof to the first-mentioned area where electric conduction is required. Because of such a smaller pressing load applied to the second-mentioned area where electric conduction is not required, the adhesive resin of the ACF 41 hardens thereat while maintaining its film thickness. For this reason, it is possible to ensure a sufficient bonding strength. Moreover, as another advantage of the present embodiment of the invention, when the first pressing area portion 45 of the heat-compressing tool 44 applies a pressing load to the first-mentioned area where electric conduction is required, a part of the ACF 41 moves from the first-pressing-area-portion (45) side to the second-pressing-area-portion (46) side. Since the ACF 41 can escape to the second-pressing-area-portion side, it is possible to avoid any ACF 41 from being pushed out from a gap between the actuator unit and the flexible cable 24.

As explained above, in a method for manufacturing an actuator unit (liquid ejecting head) according to the present embodiment of the invention, the first pressing area portion 45 of the heat-compressing tool 44 applies, to the first-mentioned area where electric conduction is required, a pressure load that is larger than that applied by the second pressing area portion 46 thereof to the second-mentioned area where electric conduction is not required at each one application of the pressure load. That is, during a thermo-compression bonding process, the pressure load of the heat-compressing tool 44 focuses on, that is, is intensively applied to, each overlapping area explained above, which is an area where electric conduction is required. For this reason, it is possible to avoid the occurrence of any significant dispersion (i.e., variability or variation) in pressure loads applied to the first-mentioned area where electric conduction is required in the thermo-compression bonding Thus, the manufacturing method according to the present embodiment of the invention makes it possible to achieve a stable connection resistance value at the first-mentioned area where electric conduction is required, thereby offering reliable electrical conduction thereat.

Moreover, when viewed in plan, a part of the common external electrode 37 is formed at each of two outside corner areas, which is located at a region close to, or at least relatively close to, the rear end of the cluster of piezoelectric elements 21 on the line connection surface 38 thereof. These two outside corner areas are located at the fixed-end-portion (21b) side of the cluster of piezoelectric elements 21. Because of such a structure, a pressure load of the heat-compressing tool 44 is intensively applied to each area corresponding to the common external electrode 37. Therefore, it is possible to achieve pressure bonding thereat in a reliable manner. It should be noted that, generally speaking, each of two outside corner areas, which is located at a region close to, or at least relatively close to, the rear end of the cluster of piezoelectric elements 21 on the line connection surface 38 thereof is a region where there is a relatively great risk that the flexible cable 24 comes off. In this respect, the manufacturing method according to the present embodiment of the invention makes it possible to reinforce the adhesion of the flexible cable 24 to the actuator unit with reliable pressure bonding at such a vulnerable area. Thus, the manufacturing method according to the present embodiment of the invention makes it possible to avoid the flexible cable 24 from coming away from the actuator unit.

Furthermore, the pressing surface 44′ of the heat-compressing tool 44 has a level difference. The first pressing area portion 45 of the heat-compressing tool 44 is protruded toward a pressure application target as viewed from the second pressing area portion 46 thereof. In other words, the first pressing area portion 45 of the heat-compressing tool 44 is protruded in the pressurizing/compressing direction. During the thermo-compression bonding of the flexible cable 24 to an actuator unit according to the present embodiment of the invention, which is a process during which the heat-compressing tool 44 applies heat and pressure to the surface of the flexible cable 24, the first pressing area portion 45 thereof becomes in contact with the overlapping area where each of the individual line terminals 24a of the flexible cable 24 substantially overlaps the corresponding one of the individual external electrodes 36 when viewed in plan and where the common line terminal 24b of the flexible cable 24 substantially overlaps the common external electrode 37 when viewed in plan. That is, when the heat-compressing tool 44 applies heat and pressure to the surface of the flexible cable 24, the first pressing area portion 45 thereof becomes in contact with a target area where electric conduction is required. Such a structure can be obtained by changing the configuration of the pressing surface (44′) of a heat-compressing tool (44), for example, by making a level difference and/or other change in the pressing surface 44′ of the heat-compressing tool 44. That is, it is possible to perform thermo-compression bonding without any necessity to modify the structure, configuration, or the like, of other device.

Although the invention is explained above while exemplifying an ink-jet recording head (recording head 1) as a typical example thereof, needless to say, the invention is also applicable to various kinds of liquid ejecting heads that eject liquid other than ink. That is, notwithstanding the foregoing, the invention may be applied to a variety of liquid ejecting heads that have an actuator unit and a flexible cable that are adhered to each other with the use of an anisotropic conductive film (ACF). Examples of a liquid ejecting head to which the invention is applicable include, without any limitation thereto: a color material ejection head that is used in the production of a color filter for a liquid crystal display device or the like; an electrode material ejection head that is used for the electrode formation of an organic electroluminescence (EL) display device, a surface/plane emission display device (FED), and the like; and a living organic material ejection head that is used for production of biochips, in addition to the ink-jet recording apparatus described above. Moreover, the invention can be embodied as a liquid ejecting apparatus that has such a liquid ejecting head as a component thereof.

The entire disclosure of Japanese Patent Application No. 2007-227439, filed Sep. 3, 2007 is incorporated by reference herein.

What is claimed is:

1. A method for manufacturing a liquid ejecting head, comprising:
positioning an actuator unit, which has a plurality of driving elements, and a line member, which applies a driving signal to the driving element, with an anisotropic electro-conductive material being sandwiched between the actuator unit and the line member in such a manner that the actuator unit and the line member substantially overlap each other when viewed in plan; and
applying pressure to an overlapping area where the actuator unit and the line member substantially overlap each other when viewed in plan with the use of a compression bonding device so as to adhere the actuator unit and the line member to each other as a result of compression,
wherein the plurality of driving elements has individual external electrodes each of which is provided for the corresponding one of the plurality of driving elements and further has a common external electrode that is common to all of the plurality of driving elements, and the common external electrode is provided at an outside corner area, which is located at a region close to, or at least relatively close to, the rear end of the plurality of driving elements on a line connection surface thereof;
the actuator unit has a first area where line terminals of the line member are positioned so as to overlap the individual external electrodes and the common external electrode when viewed in plan, which will be followed by compression bonding, and further has a second area which is different from the first area, and the compression bonding is also performed at the second area, and
the compression bonding device applies, to the first area, a pressure load that is larger than that applied to the second area at each one application of the pressure load.

2. The method for manufacturing a liquid ejecting head according to claim 1, wherein the first area is an area where electric conduction is required.

3. The method for manufacturing a liquid ejecting head according to claim 1, wherein the compression bonding is thermo-compression bonding.

4. The method for manufacturing a liquid ejecting head according to claim 1,
wherein the pressing surface of the compression bonding device has a level difference in such a manner that a first pressing area portion thereof, which corresponds to the first area, is protruded in a pressing direction toward a pressure application target as viewed from a second pressing area portion thereof, which corresponds to the second area, and
during the compression bonding of the actuator unit and the line member to each other, which is a process during which the compression bonding device applies pressure to the surface thereof, the first pressing area portion thereof becomes in contact with the first area.

5. A method for manufacturing a liquid ejecting apparatus that is provided with a liquid ejecting head that is manufactured by the liquid-ejecting-head manufacturing method according to claim 1.
